(19) United States
(12) Patent Application Publication
(10) Pub. No.: US 2026/0202840 A1
(43) Pub. Date: Jul. 16, 2026

(54) MULTI-MODE DATA MODELING METHOD AND DEVICE FOR DEGRADATION PREDICTION OF ROTATING PART

(71) Applicant: GUANGDONG UNIVERSITY OF TECHNOLOGY, Guangzhou (CN)

(72) Inventors: Yaohua DENG, Guangzhou (CN); Zilin ZHANG, Guangzhou (CN); Xiali LIU, Guangzhou (CN)

(21) Appl. No.: 19/397,553

(22) Filed: Nov. 21, 2025

(30) Foreign Application Priority Data
Jan. 10, 2025 (CN) 2025100434314

(51) Int. Cl. G05B 23/02; G06N 3/048

(52) U.S. Cl. CPC G05B 23/0281; G05B 23/0221; G05B 23/024; G05B 23/0254; G06N 3/048

(57) ABSTRACT

Disclosed are a multi-mode data modeling method and device for degradation prediction of a rotating part, and the method is used for solving the technical problem that an existing modeling method for degradation prediction of the rotating part leads to a poor model prediction accuracy. The method comprises the following steps of: acquiring to-be-trained initial multi-mode signal data, and preprocessing the to-be-trained initial multi-mode signal data based on a preset signal processing algorithm to generate to-be-trained target multi-mode signal data; calculating a degradation index according to the to-be-trained target multi-mode signal data by adopting a preset distribution function; and carrying out model training on an initial degradation prediction model of the mechanical rotating part by adopting the to-be-trained target multi-mode signal data and the degradation index to determine a target degradation prediction model of the mechanical rotating part.

### CROSS-REFERENCE TO RELATED APPLICATIONS

This application claims the benefit and priority to Chinese Patent Application No. 2025100434314, filed on Jan. 10, 2025. The DAS code for the priority application is FE18.

### TECHNICAL FIELD

The present invention relates to the technical field of artificial intelligence, and particularly to a multi-mode data modeling method and device for degradation prediction of a rotating part.

### BACKGROUND OF THE PRESENT INVENTION

Mechanical rotating part is a key component of discretely manufactured complex equipment, and the safe and stable operation of the mechanical rotating part is very important. However, with the long-term operation of the complex equipment, the mechanical part may inevitably present degradation phenomena, such as wear and fatigue, and when there are no real-time monitoring and timely intervention, the reliability and service life of the equipment will be seriously affected. Therefore, how to effectively monitor health states of key components and maintain or replace the key components in advance has become the key to improve production efficiency and reduce unplanned downtime.

In recent years, with the development of sensing technology, Internet of Things, big data analysis and artificial intelligence technology, state monitoring and fault diagnosis of a mechanical system have been changed from traditional periodic inspection to state-based predictive maintenance, a core of which lies in accurately predicting a degradation process of the mechanical part, so as to facilitate taking maintenance and remedy measures before the part completely fails, thereby effectively avoiding unexpected shutdown caused by a sudden failure and ensuring the safe and stable operation of the equipment.

According to most of existing modeling methods for degradation prediction of the rotating part, data of a single sensor are adopted to complete model training. However, in practical application, the degradation process of the mechanical part is often a result of a combined action of multiple factors, and it is difficult for the data of the single sensor to comprehensively capture a degradation trend of the part under complex working conditions, resulting in poor accuracy of model prediction.

### SUMMARY OF THE PRESENT INVENTION

The present invention provides a multi-mode data modeling method and device for degradation prediction of the rotating part, and the method is used for solving the technical problem that an existing modeling method for degradation prediction of the rotating part leads to a poor model prediction accuracy.

In a first aspect, the present invention provides a multi-mode data modeling method for degradation prediction of a rotating part, which comprises the following steps of:
acquiring to-be-trained initial multi-mode signal data, and preprocessing the to-be-trained initial multi-mode signal data based on a preset signal processing algorithm to generate to-be-trained target multi-mode signal data;
calculating a degradation index according to the to-be-trained target multi-mode signal data by adopting a preset distribution function; and
carrying out model training on an initial degradation prediction model of the mechanical rotating part by adopting the to-be-trained target multi-mode signal data and the degradation index to determine a target degradation prediction model of the mechanical rotating part.

Optionally, the preset signal processing algorithm comprises an improved ensemble empirical mode decomposition algorithm and a wavelet packet algorithm; and the step of preprocessing the to-be-trained initial multi-mode signal data based on the preset signal processing algorithm to generate the to-be-trained target multi-mode signal data, comprises:
adding a white noise to the to-be-trained initial multi-mode signal data to generate to-be-trained noise-containing signal data;
decomposing the to-be-trained noise-containing signal data by adopting the improved ensemble empirical mode decomposition algorithm, and outputting a plurality of multi-mode sub-signal data;
denoising the multi-mode sub-signal data by adopting the wavelet packet algorithm to generate a plurality of multi-mode denoised sub-signal data; and
reconstructing the plurality of multi-mode denoised sub-signal data based on a preset adaptive threshold, and outputting the to-be-trained target multi-mode signal data.

Optionally, the preset distribution function comprises an improved gamma distribution probability density function and a cumulative distribution function; and the step of calculating the degradation index according to the to-be-trained target multi-mode signal data by adopting the preset distribution function, comprises:
determining a gamma probability density distribution according to a continuous degradation amount in the to-be-trained target multi-mode signal data by adopting the improved gamma distribution probability density function;
substituting the continuous degradation amount in the to-be-trained target multi-mode signal data into the cumulative distribution function, and outputting a joint failure risk probability;
determining an instantaneous entropy value corresponding to the to-be-trained target multi-mode signal data based on the gamma probability density distribution;
carrying out a difference operation on the instantaneous entropy value and a historical entropy value corresponding to the to-be-trained target multi-mode signal data to determine an entropy value difference corresponding to the to-be-trained target multi-mode signal data; and
calculating the degradation index according to the entropy value difference and the joint failure risk probability.

Optionally, the step of carrying out the model training on the initial degradation prediction model of the mechanical rotating part by adopting the to-be-trained target multi-mode signal data and the degradation index to determine the target degradation prediction model of the mechanical rotating part, comprises:
inputting the to-be-trained target multi-mode signal data into the initial degradation prediction model of the mechanical rotating part for prediction to generate a to-be-trained predicted degradation result of the mechanical rotating part;
taking the degradation index as a real degradation result of the mechanical rotating part, and determining a model gradient according to the real degradation result of the mechanical rotating part and the to-be-trained predicted degradation result of the mechanical rotating part;
updating model parameters of the initial degradation prediction model of the mechanical rotating part by adopting the model gradient to determine an intermediate degradation prediction model of the mechanical rotating part;
determining a target loss value according to the to-be-trained target multi-mode signal data and the real degradation result of the mechanical rotating part by adopting the intermediate degradation prediction model of the mechanical rotating part and a preset root mean square error loss function;
judging whether the target loss value is converged; and
when the target loss value is converged, taking the intermediate degradation prediction model of the mechanical rotating part as the trained target degradation prediction model of the mechanical rotating part.

Optionally, the initial degradation prediction model of the mechanical rotating part comprises an embedding layer, a plurality of Mamba blocks and a linear output layer; and the step of inputting the to-be-trained target multi-mode signal data into the initial degradation prediction model of the mechanical rotating part for prediction to generate the to-be-trained predicted degradation result of the mechanical rotating part, comprises:
mapping the to-be-trained target multi-mode signal data by adopting a time vector algorithm through the embedding layer to generate multi-mode mapped signal data;
carrying out efficient sequence processing on the multi-mode mapped signal data by adopting the plurality of Mamba blocks to generate a target degradation feature; and
taking the target degradation feature as an input of the linear output layer, and outputting the to-be-trained predicted degradation result of the mechanical rotating part.

Optionally, the Mamba block comprises a first linear layer, a second linear layer, a third linear layer, a SiLU activation function layer, a dimensional channel attention module and a state space module; and a data processing process of the Mamba block comprises:
linearly transforming input multi-mode signal data input into the Mamba block through the first linear layer and the second linear layer respectively to generate a first multi-mode transformed signal feature and a second multi-mode transformed signal feature;
nonlinearly mapping the first multi-mode transformed signal feature by adopting the SiLU activation function layer, and outputting a multi-mode nonlinear signal feature;
carrying out cross-dimensional channel information capture on the second multi-mode transformed signal feature through the dimensional channel attention module to generate a multi-mode attention signal feature;
multiplying the multi-mode attention signal feature and the second multi-mode transformed signal feature, and outputting a first multi-mode multiplied signal feature;
carrying out feature extraction on the first multi-mode multiplied signal feature by adopting the state space module to generate a signal degradation feature;
multiplying the signal degradation feature and the multi-mode nonlinear signal feature, and outputting a second multi-mode multiplied signal feature; and
linearly transforming the second multi-mode multiplied signal feature by adopting the third linear layer to generate an output signal feature.

Optionally, the method further comprises:
when receiving to-be-detected initial multi-mode signal data, preprocessing the to-be-detected initial multi-mode signal data based on the preset signal processing algorithm to generate to-be-detected target multi-mode signal data; and
predicting the to-be-detected target multi-mode signal data by adopting the target degradation prediction model of the mechanical rotating part to generate a target predicted degradation result of the mechanical rotating part.

In a second aspect, the present invention provides a multi-mode data modeling device for degradation prediction of a rotating part, which comprises:
an acquisition module configured for acquiring to-be-trained initial multi-mode signal data, and preprocessing the to-be-trained initial multi-mode signal data based on a preset signal processing algorithm to generate to-be-trained target multi-mode signal data;
a calculation module configured for calculating a degradation index according to the to-be-trained target multi-mode signal data by adopting a preset distribution function; and
a training module configured for carrying out model training on an initial degradation prediction model of the mechanical rotating part by adopting the to-be-trained target multi-mode signal data and the degradation index to determine a target degradation prediction model of the mechanical rotating part.

In a third aspect, the present invention provides a computer device, which comprises a storage and a processor, wherein the storage stores a computer program, and when the computer program is executed by the processor, the processor executes the steps of the multi-mode data modeling method for degradation prediction of the rotating part above.

In a fourth aspect, the present invention provides a computer-readable storage medium, which stores a computer program, wherein, when the computer program is executed, the steps of the multi-mode data modeling method for degradation prediction of the rotating part above are implemented.

It can be seen from the above technical solution that the present invention has the following advantages.

The above technical solution of the present invention provides the multi-mode data modeling method for degradation prediction of the rotating part, wherein, firstly, the to-be-trained initial multi-mode signal data are acquired, and the to-be-trained initial multi-mode signal data are preprocessed based on the preset signal processing algorithm to generate the to-be-trained target multi-mode signal data; subsequently, the degradation index is calculated according to the to-be-trained target multi-mode signal data by adopting the preset distribution function; and finally, the model training is carried out on the initial degradation prediction model of the mechanical rotating part by adopting the to-be-trained target multi-mode signal data and the degradation index to determine the target degradation prediction model of the mechanical rotating part. Based on the above solution, in the present invention, the process of carrying out the model training on the initial degradation prediction model of the mechanical rotating part by adopting the to-be-trained target multi-mode signal data preprocessed and combining with the degradation index output by the preset distribution function to determine the target degradation prediction model of the mechanical rotating part can overcome limitations of a traditional prediction method based on single-mode data, and provide more comprehensive degradation information for prediction modeling, thereby improving the accuracy of model prediction.

### DESCRIPTION OF THE DRAWINGS

In order to illustrate the technical solutions in the embodiments of the present invention or in the prior art more clearly, the drawings used in the descriptions of the embodiments or the prior art will be briefly described below. Obviously, the drawings in the following descriptions are merely some embodiments of the present invention. For those of ordinary skills in the art, other drawings may also be obtained based on these drawings without going through any creative work.

FIG. 1 is a flow chart of steps of a multi-mode data modeling method for degradation prediction of a rotating part provided by First Embodiment of the present invention;

FIG. 2 is a frame diagram of multi-mode data modeling for degradation prediction of the rotating part provided by First Embodiment of the present invention;

FIG. 3 is a flow chart of execution of a multi-mode data modeling method for degradation prediction of a rotating part provided by Second Embodiment of the present invention;

FIG. 4 is a flow chart of steps of model prediction of a target degradation prediction model of a mechanical rotating part provided by Third Embodiment of the present invention; and

FIG. 5 is a structural frame diagram of a multi-mode data modeling device for degradation prediction of a rotating part provided by Fourth Embodiment of the present invention.

### DETAILED DESCRIPTION OF PREFERRED EMBODIMENTS

The embodiments of the present invention provide a multi-mode data modeling method and device for degradation prediction of a rotating part, and the method is used for solving the technical problem that an existing modeling method for degradation prediction of the rotating part leads to a poor model prediction accuracy.

In order to make the objectives, features and advantages of the present invention more obvious and easier to understand, the technical solutions in the embodiments of the present invention are clearly and completely described hereinafter with reference to the drawings in the embodiments of the present invention. Obviously, the embodiments described hereinafter are only some but not all of the embodiments of the present invention. Based on the embodiments in the present invention, all other embodiments obtained by those of ordinary skills in the art without going through any creative work should fall within the scope of protection of the present invention.

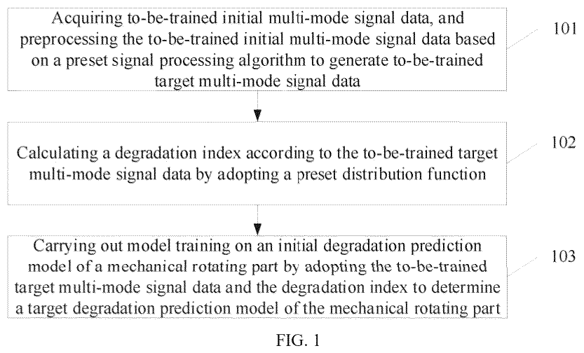

With reference to FIG. 1, FIG. 1 is a flow chart of steps of a multi-mode data modeling method for degradation prediction of a rotating part provided by First Embodiment of the present invention.

The multi-mode data modeling method for degradation prediction of the rotating part provided by the present invention comprises the following steps.

In step 101, to-be-trained initial multi-mode signal data are acquired, and the to-be-trained initial multi-mode signal data are preprocessed based on a preset signal processing algorithm to generate to-be-trained target multi-mode signal data.

The preset signal processing algorithm comprises an improved ensemble empirical mode decomposition algorithm and a wavelet packet algorithm.

The to-be-trained initial multi-mode signal data are multi-mode signal data used for model training, and the multi-mode signal data comprise various signal data of a whole life cycle of a part, such as a temperature, an acoustic emission, a vibration, and the like.

It should be noted that, under complex working conditions, a large number of noise signals may be collected from sensor signals, such as the vibration or the acoustic emission (the multi-mode signal data), due to their high-frequency sampling feature, and in order to improve a signal-to-noise ratio of the vibration signal, it is necessary to carry out denoising preprocessing; wherein, a denoising algorithm of improved ensemble empirical mode decomposition (EEMD) combined with a wavelet threshold is a commonly used method in the field of signal processing, which can effectively remove noise components in the signal, thereby avoiding the problem of excessive denoising. Therefore, in the present invention, the denoising method of EEMD combined with the wavelet threshold is adopted for denoising preprocessing of the signal.

Specifically, the process of preprocessing the to-be-trained initial multi-mode signal data based on the preset signal processing algorithm to generate the to-be-trained target multi-mode signal data, may be implemented by executing the following sub-steps S11 to S14.

In step S11, a white noise is added to the to-be-trained initial multi-mode signal data to generate to-be-trained noise-containing signal data.

It should be noted that an original signal x(t) (the to-be-trained initial multi-mode signal data) is added with an auxiliary white noise signal to obtain the to-be-trained noise-containing signal data Xₙ(t), wherein, the to-be-trained noise-containing signal data Xₙ(t) may be expressed as:

$${X}_{n} ( t ) = {\sum }_{n = 1}^{N} {IMF}_{n} ( t ) + r ( t ) ;$$

wherein, Xₙ(t) is the to-be-trained noise-containing signal data; r(t) is a residual component; N is an order of a decomposed IMF; and IMFₙ(t) is a component of an n^{th} order of IMF.

In step S12, the to-be-trained noise-containing signal data are decomposed by adopting the improved ensemble empirical mode decomposition algorithm, and a plurality of multi-mode sub-signal data are output.

It should be noted that a noise-containing signal (the to-be-trained noise-containing signal data) is decomposed by using the EEMD to obtain a decomposition result x′(t) (the plurality of multi-mode sub-signal data).

In step S13, the multi-mode sub-signal data are denoised by adopting the wavelet packet algorithm to generate a plurality of multi-mode denoised sub-signal data.

In step S14, the plurality of multi-mode denoised sub-signal data are reconstructed based on a preset adaptive threshold, and the to-be-trained target multi-mode signal data are output.

It should be noted that the wavelet packet algorithm is used to denoise a noise-containing signal (the multi-mode denoised sub-signal data). In order to prevent the loss of useful information in the data, a noise standard deviation estimation is introduced to design an adaptive threshold (the preset adaptive threshold), and finally, a finally denoised signal (the to-be-trained target multi-mode signal data) is reconstructed; wherein, the adaptive threshold is calculated as shown in the following formula:

$$λ = α * σ \sqrt{2 log N} , σ = \frac{MAD}{0.6745} ;$$

wherein, λ is the preset adaptive threshold; α is a threshold factor, which is set to be 0.5; σ is the noise standard deviation estimation; N is a signal length; MAD is a median of an absolute value of a difference between a detail coefficient of wavelet transform and its median; and 0.6745 represents a ratio of an absolute deviation to a standard deviation of a median in a normal distribution.

In this embodiment, the to-be-trained initial multi-mode signal data are acquired, and the to-be-trained initial multi-mode signal data are preprocessed based on the preset signal processing algorithm to generate the to-be-trained target multi-mode signal data.

In step 102, a degradation index is calculated according to the to-be-trained target multi-mode signal data by adopting a preset distribution function.

The preset distribution function comprises an improved gamma distribution probability density function and a cumulative distribution function.

It should be noted that, in a construction stage of the degradation index, according to an existing health index construction method, only a signal of a single sensor is used, which is not enough to comprehensively reflect an overall health status of the system. In the present invention, information of multiple sensors is adopted to obtain more comprehensive degradation features of the part, and according to a gamma distribution and a Bayesian inference, comprehensive degradation index construction based on a combination of a failure risk probability and an entropy value difference is proposed.

Further, the step 102 may comprise the following sub-steps.

In S21, a gamma probability density distribution is determined according to a continuous degradation amount in the to-be-trained target multi-mode signal data by adopting the improved gamma distribution probability density function.

It should be noted that, considering that a degradation process of a mechanical part of complex equipment is continuous and monotonous in the case of no repair action, and a gamma process is also a non-negative and strictly monotonous random process, with a monotonous, stable and independent Gaussian increment, the degradation process of the part caused by wear and the like may be well described. Therefore, in the present invention, assuming that the continuous degradation process of the key part is subject to the gamma process, a continuous degradation amount of the part at any moment is subject to the gamma distribution, wherein the continuous degradation amount is obtained by non-negative conversion (such as calculating its effective value) of original data. In addition, a time-varying shape parameter and an initial degradation offset are introduced to obtain a gamma distribution probability density function describing the degradation process of the part, which is the improved gamma distribution probability density function, and is specifically as follows:

$$f ( s ; t ) = s ( t ) \sim Ga ( s \vert α ( t ) , β , μ ) = \frac{{β}^{α ( t )}}{Γ ( α ( t ) )} {( s - μ )}^{α ( t ) - 1} exp \{ - β ( s - μ ) \} {I}_{( μ , ∞ )} ( s ) ;$$

wherein, f(s;t) is the gamma probability density distribution; s(t) is continuous degradation amount; Ga(s|α(t),β,μ) is the gamma distribution; Γ(α(t)) is a gamma function; β is a scale parameter; α(t) is a shape parameter varying with time t; s is an observation data input; μ is an offset term, which indicates an initial value at the beginning of degradation; and I_{(μ,∞)}(s) is an indicator function, which ensures that the s is within the interval I_{(μ,∞)}(s).

It is worth mentioning that a value of the α(t) is increased with time, which indicates that a cumulative effect in the degradation process is obvious, for example, with the increase of service time, a degradation degree of the part is increased significantly. The β indicates a significant degree of degradation, wherein the smaller the β, the faster the degradation rate, and the larger the β, the slower the degradation rate. The initial degradation offset μ may be conductive to calibrating a starting point of the degradation model to make it closer to an actual situation.

In S22, the continuous degradation amount in the to-be-trained target multi-mode signal data is substituted into the cumulative distribution function, and a joint failure risk probability is output.

It should be noted that, in order to dynamically adjust the degradation index and evaluate an uncertainty of a degradation state of the part, the Bayesian inference is introduced to estimate parameters of degradation data distribution, and prior knowledge is combined with observation data to infer a posterior distribution. The posterior distribution is defined as follows:

$$P ( α ( t ) , β \vert {s}_{t - 1} ) = Ga ( {α ( t )}_{n} , {β}_{n} ) ;$$

wherein, sₜ₋₁ is an observation data input at a moment t−1, which is an observation data input in past time; α(t)ₙ is a first updated parameter of the posterior distribution; βₙ is a second updated parameter of the posterior distribution; P(α(t),β|sₜ₋₁) is the posterior distribution; and Ga(α(t)ₙ,βₙ) is a gamma distribution obtained by a posterior inference under the observed value sₜ₋₁.

Further, a likelihood function is defined as follows:

$$L ( α ( t ) , β , μ \vert {s}_{i} ) = Ga ( {s}_{i} \vert α ( t ) , β , μ ) ;$$

wherein, L(α(t),β,μ|sᵢ) is the likelihood function, which represents a joint probability distribution of the parameters α(t),β,μ in the case of known observation data sᵢ; sᵢ is an observation sample at a moment i; and P(α(t),β|sₜ₋₁) is a gamma distribution probability density function of the observed value sᵢ under the given parameters α(t),β,μ.

Furthermore, the Bayesian inference is a parameter estimation based on a Bayesian theorem, which combines the prior knowledge with the likelihood function to update the posterior distribution of the parameters. A posterior probability distribution is calculated as follows:

$${p}^{′} ( s \vert θ ) = \frac{p ( θ ) G a ( s \vert θ )}{{\int }_{θ} p ( θ ) G a ( s \vert θ ) d θ} ;$$

wherein, p′(s|θ) is the posterior probability distribution; p(θ) a prior distribution; Ga(s|θ) is the likelihood function; θ is the parameters α(t), β and μ; and s is an observation sample.

Through a construction process of a degradation data distribution model according to the Bayesian inference above, a degradation data distribution model based on a plurality of variables may be obtained, and in order to achieve comprehensive understanding and evaluation of degradation of the part, a multi-variable joint distribution model is constructed in the present invention. Assuming that two variables of the vibration and the temperature are adopted, the joint distribution model is defined as follows:

$$H ( v , t ) = C ( {F}_{V} ( v ) , {F}_{T} ( t ) ) ;$$

wherein, H(v,t) is the joint distribution model; F_{V}(v) is a marginal distribution function of the vibration; F_{T}(t) is a marginal distribution function of the temperature; v is an observed value of a vibration degradation amount; t is an observed value of a temperature degradation amount; and C is a Gaussian Couple function.

Further, the Gaussian Couple function may be expressed as follows:

$$C ( {η}_{1} , {η}_{2} ) = {Φ}_{R} ( {Φ}^{- 1} ( {η}_{1} ) , {Φ}^{- 1} ( {η}_{2} ) ) ;$$

wherein, Φ s a cumulative distribution function of a standard normal distribution; Φ⁻¹ is an inverse cumulative function of the standard normal distribution; Φ_{R} is a cumulative distribution function of a bivariate standard normal distribution of a correlation coefficient R; η₁ is a first standardized variable, a value range of which is [0, 1]; and η₂ is a second standardized variable, a value range of which is [0, 1].

Subsequently, the degradation index is calculated, comprising calculation of the failure risk probability and calculation of the entropy value difference. For a degradation amount of a certain variable, a threshold τ is given, and a probability of exceeding the threshold is P(X>τ):

$$R ( t ) = P ( X > τ ) = 1 - P ( X \leq τ ) = 1 - {F}_{G a} ( τ ; θ ) ;$$

wherein, F_{Ga}(τ;θ) is a marginal distribution function of the gamma distribution; P(X≤τ) is a probability of being less than or equal to the threshold; and R(t) is a failure risk probability of the part calculated based on a distribution of a certain variable at a moment t.

On the above basis, assuming that the to-be-trained target multi-mode signal data comprise two variables of the vibration and the temperature, a calculation process of the corresponding joint failure risk probability may be expressed as follows:

$${R}_{C} = P ( V > {τ}_{v} , T > {τ}_{t} ) = 1 - C ( {F}_{V} ( {τ}_{v} ) , {F}_{T} ( {τ}_{t} ) ) ;$$

wherein, R_{C} is the joint failure risk probability; τᵥ is a threshold of a vibration degradation amount; τₜ is a threshold of a temperature degradation amount; V is the vibration degradation amount; T is the temperature degradation amount; F_{V}(·) and F_{T}(·) are respectively cumulative distribution functions of the vibration and temperature degradation amounts; and C is a Gaussian Couple function.

It is worth mentioning that the cumulative distribution function may refer to a specific expression of an existing cumulative distribution function, which will not be repeated in the present invention.

In S23, an instantaneous entropy value corresponding to the to-be-trained target multi-mode signal data is determined based on the gamma probability density distribution.

It should be noted that, when evaluating a running state of the part varying with time in the whole life cycle, an unstable change of the running state of the part may be reflected by calculating the entropy value difference distributed in two time periods before and after. Assuming that f(s;t) is a probability density function of the state of the part at a moment, an entropy value at the moment is the instantaneous entropy value H(t) corresponding to the to-be-trained target multi-mode signal data determined based on the gamma probability density distribution; wherein, this process may be expressed as follows:

$$H ( t ) = - \int f ( s ; t ) log ( f ( s ; t ) ) dx ;$$

wherein, H(t) is the instantaneous entropy value; and f(s;t) is the gamma probability density distribution.

In S24, a difference operation is carried out on the instantaneous entropy value and a historical entropy value corresponding to the to-be-trained target multi-mode signal data to determine an entropy value difference corresponding to the to-be-trained target multi-mode signal data.

The historical entropy value is an entropy value at a previous moment corresponding to the to-be-trained target multi-mode signal data.

It should be noted that, assuming that, in time periods tₙ and tₙ₋₁, a change ΔH of the calculated entropy value may be expressed as the entropy value difference in two time periods before and after, a calculation process of the entropy value difference corresponding to the to-be-trained target multi-mode signal data may be expressed as follows:

$$Δ H = H ( {t}_{n} ) - H ( {t}_{n - 1} ) ;$$

wherein, ΔH is the entropy value difference corresponding to the to-be-trained target multi-mode signal data; H(tₙ) is the instantaneous entropy value corresponding to the to-be-trained target multi-mode signal data; and H(tₙ₋₁) is the historical entropy value corresponding to the to-be-trained target multi-mode signal data.

In S25, the degradation index is calculated according to the entropy value difference and the joint failure risk probability.

It should be noted that, when constructing the degradation index, the entropy value difference may be used to measure a degree of uncertainty change in a system degradation process. A more comprehensive degradation index may be formed by combining the entropy value difference with the reliability. Assuming that the to-be-trained target multi-mode signal data comprise two variables of the vibration and the temperature, a calculation process of the corresponding degradation index may be expressed as follows:

$$D I = λ {R}_{C} ( t ) + μ ( Δ {H}_{V} ( t ) + Δ {H}_{T} ( t ) ) ;$$

wherein, DI is the degradation index; λ is a weight factor of the failure risk probability; R_{C}(t) is a joint failure risk probability at a moment t; μ is a weight factor of the entropy value difference; ΔH_{V}(t) is an entropy value difference corresponding to a vibration variable; and ΔH_{T}(t) is an entropy value difference corresponding to a temperature variable.

In this embodiment, the degradation index is calculated according to the to-be-trained target multi-mode signal data by adopting the preset distribution function.

In step 103, model training is carried out on an initial degradation prediction model of the mechanical rotating part by adopting the to-be-trained target multi-mode signal data and the degradation index to determine a target degradation prediction model of the mechanical rotating part.

Specifically, the step 103 may comprise the following sub-steps S31 to S36.

In step S31, the to-be-trained target multi-mode signal data are input into the initial degradation prediction model of the mechanical rotating part for prediction to generate a to-be-trained predicted degradation result of the mechanical rotating part.

It should be noted that, in a modeling stage of degradation trend prediction, aiming at the problem of long-range dependency modeling, a Mamba prediction network based on a state space model is adopted in the present invention for degradation trend prediction of the part. The state space model is a model for describing time-varying evolution of a state by using an ordinary differential equation, which is suitable for a time series modeling task. On the basis of the state space model, the Mamba model achieves efficient representation of cumulative historical information in a limited storage space by introducing a HiPPO matrix, and adopts a selection mechanism to filter out irrelevant information and reset the state, so as to enhance a traditional state space model, thereby achieving fast inference and long-range dependency modeling. In the present invention, there is an improvement based on the Mamba model, which puts forward an improved Mamba degradation prediction model based on attention fusion, which is the initial degradation prediction model of the mechanical rotating part, and the model comprises three parts, which are an embedding layer, N Mamba blocks and a linear output layer respectively.

Further, the step S31 may comprise the following sub-steps.

In step S311, the to-be-trained target multi-mode signal data are mapped by adopting a time vector algorithm through the embedding layer to generate multi-mode mapped signal data.

It should be noted that a Time2vec algorithm (a time vector algorithm) is adopted in the embedding layer to map time series data, representation of a time step is learned through a linear layer and a periodic activation function together according to a basic idea, and this algorithm will map the time step to a vector space with a specific dimension, so that a periodic mode and an aperiodic mode in time series data can be captured. In the context of time fluctuation, similar features can still remain stable and unchanged, which is achieved by the following formula:

$${x}_{e m b} = \{ \begin{matrix}{ω}_{i} {x}_{in} + {φ}_{i} & if i = 0 \\ F ( {ω}_{i} {x}_{in} + {φ}_{i} ) , & if 1 \leq i < k\end{matrix} ;$$

wherein, x_{emb} is multi-mode mapped signal data; xᵢₙ is the to-be-trained target multi-mode signal data; ωᵢ is a weight; φᵢ is a bias; F is the periodic activation function; k is a dimension of time2vec; and i is a dimension index.

Further, assuming that Batchsize is set as b, a length of the time series data is set as L and a quantity of input features is set as D, input time series data are xᵢₙ∈R^{B×L×D}, which are output as x_{emb}∈R^{B×L×D} after passing through the embedding layer of time2vec.

In step S312, efficient sequence processing is carried out on the multi-mode mapped signal data by adopting the plurality of Mamba blocks to generate a target degradation feature.

It should be noted that the plurality of Mamba blocks are cascaded, the multi-mode mapped signal data are processed by the Mamba blocks in sequence (which means that an output of a previous Mamba block is an input of a next Mamba block), and feature data output by a last Mamba block are taken as the target degradation feature.

Optionally, the Mamba block comprises a first linear layer, a second linear layer, a third linear layer, a SiLU activation function layer, a dimensional channel attention module and a state space module; and a data processing process of the Mamba block comprises:
S1: linearly transforming input multi-mode signal data input into the Mamba block through the first linear layer and the second linear layer respectively to generate a first multi-mode transformed signal feature and a second multi-mode transformed signal feature;
S2: nonlinearly mapping the first multi-mode transformed signal feature by adopting the SiLU activation function layer, and outputting a multi-mode nonlinear signal feature;
S3: carrying out cross-dimensional channel information capture on the second multi-mode transformed signal feature through the dimensional channel attention module to generate a multi-mode attention signal feature;
S4: multiplying the multi-mode attention signal feature and the second multi-mode transformed signal feature, and outputting a first multi-mode multiplied signal feature;
S5: carrying out feature extraction on the first multi-mode multiplied signal feature by adopting the state space module to generate a signal degradation feature;
S6: multiplying the signal degradation feature and the multi-mode nonlinear signal feature, and outputting a second multi-mode multiplied signal feature; and
S7: linearly transforming the second multi-mode multiplied signal feature by adopting the third linear layer to generate an output signal feature.

The input multi-mode signal data are signal data input into the Mamba block, and it can be understood that the input multi-mode signal data may correspond to any signal data input into the Mamba block for data processing in a process of model training or prediction.

The first multi-mode transformed signal feature, the second multi-mode transformed signal feature, the multi-mode nonlinear signal feature, the multi-mode attention signal feature, the first multi-mode multiplied signal feature, the signal degradation feature and the second multi-mode multiplied signal feature are all intermediate feature data generated in the Mamba block.

The output signal feature is feature data output by the Mamba block, and it can be understood that the output signal feature may correspond to any output feature data after data processing by the Mamba block in the process of model training or prediction.

It should be noted that the multi-mode mapped signal data enter N Mamba modules (Mamba blocks) for processing, and the Mamba module mainly comprises linear layers (the first linear layer, the second linear layer and the third linear layer), a dimensional channel attention module and a SSM module (State Space Model Module). A data processing process of the Mamba module may be expressed as follows:

$${x}_{m a m b a} = Linear \{ S SM [ Attention ( Linear ( {x}_{e m b} ) ) * Linear ( {x}_{e m b} ) ] * Si LU ( Linear ( {x}_{e m b} ) ) \} ;$$

wherein, x_{mamba} is the output signal feature, and the output signal feature output by the last Mamba block is taken as the target degradation feature; Linear(·) is a linear transformation layer (linear layer); SiLU(·) is a composite activation function based on a Sigmoid function and a Linear function; Attention(·) is the dimensional channel attention module, which has a good ability to capture cross-dimensional channel information; and SSM(·) is the SSM module.

Further, a processing process of the first multi-mode multiplied signal feature may be expressed as follows:

$$Attention ( {x}_{a} ) = σ ( C 1 D ( G A P ( {x}_{a} ) ) ) □ {x}_{a} ;$$

wherein, xₐ is the second multi-mode transformed signal feature; Attention(xₐ) is the first multi-mode multiplied signal feature; σ is the Sigmoid activation function; GAP is a global average pooling operation; CID is a 1×1 convolution operation; and · is multiplication.

Further, the SSM module maps an input signal to a corresponding output through state representation, and this step is used to describe a time-varying evolution process of a degradation state of the part for degradation feature extraction, which is mainly implemented by a formula as follows:

$${h}_{k} = \overline{A} {h}_{k - 1} + \overline{B} {x}_{k}$$

$${y}_{k} = \overline{C} {h}_{k} + \overline{D} {x}_{k} ;$$

wherein, hₖ is a state vector at a moment k; Ā is a first discretization parameter of the SSM module; hₖ₋₁ is a state vector at a moment k−1; B̅ is a second discretization parameter of the SSM module; xₖ is an input vector of the SSM module at the moment k; yₖ is an output vector of the SSM module at the moment k; C̅ is a third discretization parameter of the SSM module; and D̅ is a fourth discretization parameter of the SSM module.

It is worth mentioning that a selective scanning mechanism is introduced into the Mamba to enhance an interaction between sequences, so that the model may filter out noise information irrelevant to a time series task, and selectively spread or forget currently input relevant information at the same time.

In step S313, the target degradation feature is taken as an input of the linear output layer, and the to-be-trained predicted degradation result of the mechanical rotating part is output.

Further, the operation finally enters the linear output layer, and this layer comprises two linear layers and one activation function. Specific calculation is as follows:

$${y}_{output} = σ ( {W}_{2} ( {W}_{1} ( {x}_{m a m b a} ) + {b}_{1} ) + {b}_{2} ) ;$$

Wherein, yₒᵤₜₚᵤₜ is an output predicted degradation value, which is the to-be-trained predicted degradation result of the mechanical rotating part; σ is the Sigmoid activation function; W₂ is a second weight matrix of the linear layer; W₁ is a first weight matrix of the linear layer; x_{mamba} is the target degradation feature; b₁ is a first bias vector of the linear layer; and b₂ is a second bias vector of the linear layer.

In step S32, the degradation index is taken as a real degradation result of the mechanical rotating part, and a model gradient is determined according to the real degradation result of the mechanical rotating part and the to-be-trained predicted degradation result of the mechanical rotating part.

It should be noted that the degradation index is taken as the real degradation result (a true value) of the mechanical rotating part, and substituted into a root mean square error (RMSE) loss function together with the to-be-trained predicted degradation result of the mechanical rotating part for derivation to determine the model gradient.

In step S33, model parameters of the initial degradation prediction model of the mechanical rotating part are updated by adopting the model gradient to determine an intermediate degradation prediction model of the mechanical rotating part.

In step S34, a target loss value is determined according to the to-be-trained target multi-mode signal data and the real degradation result of the mechanical rotating part by adopting the intermediate degradation prediction model of the mechanical rotating part and a preset root mean square error loss function.

It should be noted that the degradation index is taken as the real degradation result (the true value) of the mechanical rotating part, and substituted into the root mean square error (RMSE) loss function together with the to-be-trained predicted degradation result of the mechanical rotating part to calculate the target loss value.

In step S35, whether the target loss value is converged is judged.

In step S36, when the target loss value is converged, the intermediate degradation prediction model of the mechanical rotating part is taken as the trained target degradation prediction model of the mechanical rotating part.

It should be noted that, when the target loss value is not converged, the intermediate degradation prediction model of the mechanical rotating part is taken as a new initial degradation prediction model of the mechanical rotating part, and the operation jumps to the step S31 until the target loss value is converged. The intermediate degradation prediction model of the mechanical rotating part determined when the target loss value is converged is taken as the trained target degradation prediction model of the mechanical rotating part.

In this embodiment, the model training is carried out on the initial degradation prediction model of the mechanical rotating part by adopting the to-be-trained target multi-mode signal data and the degradation index to determine the target degradation prediction model of the mechanical rotating part.

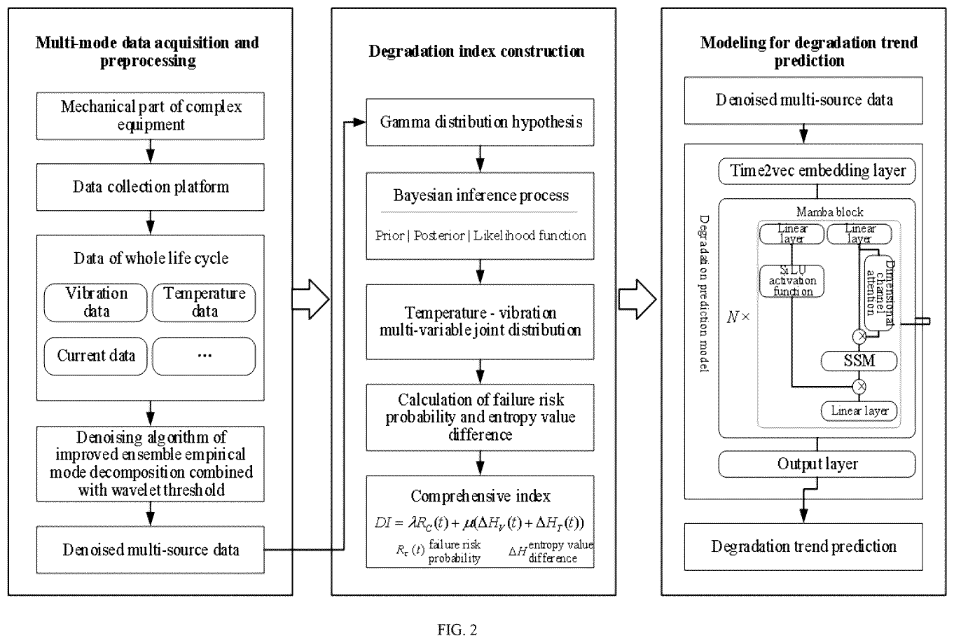

Illustratively, with reference to FIG. 2, a frame of the multi-mode data modeling for degradation prediction of the rotating part provided by the present invention is divided into three steps, comprising multi-mode data acquisition and preprocessing, degradation index construction and degradation trend prediction modeling. Firstly, in a stage of multi-mode data acquisition and preprocessing, the mechanical part of the complex equipment is comprehensively monitored by using multi-source sensors, and various signal data (the initial multi-mode signal data) of the whole life cycle of the part, such as the temperature and the vibration, are collected. In order to improve a data quality, an original signal is denoised by adopting a denoising algorithm of improved ensemble empirical mode decomposition combined with a wavelet threshold (the preset signal processing algorithm), so as to obtain denoised multi-source data (the target multi-mode signal data). Secondly, in a stage of degradation index construction, considering that the mechanical part shows a non-negativity and a strict monotonicity in the degradation process such as wear, and the gamma distribution is a non-negative random variable distribution, the gamma distribution is selected as a probability model to describe the degradation process in the present invention. In order to better evaluate an uncertainty of the degradation state of the part and achieve a dynamic adjustment of the degradation index, the Bayesian inference is introduced for parameter estimation in the present invention, and the posterior distribution is inferred in the degradation process by combining the prior knowledge with the observation data. On this basis, a multi-variable joint distribution model is constructed according to a distribution situation of the multi-source data, a calculation formula for the failure risk probability is constructed according to a cumulative distribution function of the gamma distribution, and one comprehensive degradation index is constructed according to a change of the entropy value. Finally, in a stage of degradation prediction modeling, an improved Mamba degradation prediction model (the degradation prediction model of the mechanical rotating part) based on attention mechanism fusion) is constructed in the present invention, which combines advantages of both the state space model and the dimensional attention mechanism, thereby effectively extracting a degradation feature of time-varying evolution, and achieving accurate degradation trend prediction of the mechanical part.

As a comparison of technical effects, the prior art may be used as a reference. At present, the modeling method for degradation prediction of the mechanical part mostly relies on data of a single sensor. However, in practical application, the degradation process of the mechanical part is often a result of a combined action of multiple factors, and it is difficult for the data of the single sensor to comprehensively capture a degradation trend of the part under complex working conditions.

In order to make up for the limitation of insufficient information of the single sensor, the present invention provides the multi-mode data modeling method for degradation prediction of the rotating part, thereby achieving accurate degradation evolution trend prediction of the mechanical part. Specifically, the gamma distribution with the time-varying shape parameter and the initial degradation offset is used to describe the degradation process of the mechanical part due to wear and other reasons, and meanwhile, the Bayesian inference is adopted for parameter estimation of data distribution in the degradation process, so as to achieve the dynamic adjustment of the degradation index and the uncertainty evaluation under the degradation state of the part. Subsequently, a calculation formula for the comprehensive degradation index is designed by combining the failure risk probability with the entropy value difference, and this index may be used to evaluate the health state of the mechanical part from multiple dimensions, thereby being a more comprehensive and accurate comprehensive degradation index. Finally, the degradation trend of the part is predicted by adopting the trained Mamba degradation prediction model (the target degradation prediction model of the mechanical rotating part) based on attention mechanism fusion. With reference to the above contents, after the steps of the proposed system, the accurate degradation trend prediction of the mechanical part can be effectively achieved in practical application.

To sum up, in the present invention, the running state of the mechanical part of the complex equipment is comprehensively monitored through the multi-source sensors (such as a vibration, a temperature and an acoustic emission), multi-source signal data of the whole life cycle of the part are collected, and the data reflect a degradation trend process of the mechanical part from different angles and provide more comprehensive degradation information for subsequent degradation index construction and prediction modeling, thereby overcoming limitations of a traditional prediction method based on single-mode data. The present invention further innovatively proposes to describe the degradation process of the mechanical part due to wear and other reasons by using the gamma distribution with the time-varying shape parameter and the initial degradation offset, so that the model can more flexibly adapt to different degradation forms of different mechanical parts. Meanwhile, the Bayesian inference is used for parameter estimation of data distribution in the degradation process, so as to achieve the dynamic adjustment of the degradation index and the uncertainty evaluation under the degradation state of the part. Meanwhile, in the present invention, a multi-variable joint distribution is designed, and the failure risk probability of the mechanical part at a specific time point is calculated according to the cumulative distribution function of the gamma distribution by setting the threshold; and meanwhile, the entropy value difference between data distributions in two adjacent time periods is calculated to measure a time-varying instability increase of the part. By combining the failure risk probability with the entropy value difference, and introducing the weight factor of the failure risk probability and the weight factor of the entropy value difference which are adjustable as needed, one more comprehensive and accurate comprehensive degradation index of the mechanical part is constructed. In addition, the present invention innovatively proposes the improved Mamba degradation prediction model based on dimensional attention mechanism fusion, and this model comprises the embedding layer, the Mamba block and the output layer. The embedding layer maps the time series data by adopting the Time2vec algorithm to capture the periodic and aperiodic features in the time series data. The Mamba block innovatively integrates the state space model with the dimensional channel attention module, wherein the state space model can effectively describe a time-varying evolution process of a state for extraction of the time-varying degradation feature. The dimensional channel attention mechanism has an excellent ability to capture the cross-dimensional information, and can efficiently fuse the multi-source data. The model may effectively extract the degradation feature of the whole life cycle of the mechanical part, thereby achieving high-accuracy degradation trend prediction of the part.

In the embodiment of the present invention, the present invention provides the multi-mode data modeling method for degradation prediction of the rotating part, wherein, firstly, the to-be-trained initial multi-mode signal data are acquired, and the to-be-trained initial multi-mode signal data are preprocessed based on the preset signal processing algorithm to generate the to-be-trained target multi-mode signal data; subsequently, the degradation index is calculated according to the to-be-trained target multi-mode signal data by adopting the preset distribution function; and finally, the model training is carried out on the initial degradation prediction model of the mechanical rotating part by adopting the to-be-trained target multi-mode signal data and the degradation index to determine the target degradation prediction model of the mechanical rotating part. Based on the above solution, in the present invention, the process of carrying out the model training on the initial degradation prediction model of the mechanical rotating part by adopting the to-be-trained target multi-mode signal data preprocessed and combining with the degradation index output by the preset distribution function to determine the target degradation prediction model of the mechanical rotating part can overcome limitations of a traditional prediction method based on single-mode data, and provide more comprehensive degradation information for prediction modeling, thereby improving the accuracy of model prediction.

For better description, FIG. 3 shows a flow chart of execution of a multi-mode data modeling method for degradation prediction of a rotating part provided by Second Embodiment of the present invention. It should be pointed out that, this embodiment only briefly describes a general flow of the multi-mode data modeling method for degradation prediction of the rotating part, and a specific implementation process of each step may be understood by referring to relevant contents in the above-mentioned embodiment, which will not be repeated herein. It can be understood that this is not limited by the present invention.
(1) Collection of degradation data of mechanical part: the degradation data of the whole life cycle of the mechanical part, such as the vibration, the acoustic emission, the temperature and other data, are collected by adopting the multi-source sensors to ensure an integrity and an availability of the data.
(2) Data preprocessing: a to-be-denoised signal is denoised based on the algorithm of improved ensemble empirical mode decomposition combined with the wavelet threshold, and then subjected to normalization or standardization preprocessing; and the data are partitioned into multiple samples according to a time sequence by adopting a sliding window partitioning method, and the samples are divided into a training set, a verification set and a test set.
(3) Degradation index construction: a preliminary degradation amount index is constructed by using the preprocessed multi-mode data, for example, an effective value of a vibration signal may be taken as the degradation amount index, which is used as an input in the stage of degradation index construction, and then the degradation index is extracted by the above processes of the gamma distribution, the Bayesian inference, the calculation of the failure risk probability, the calculation of the entropy value, the calculation of the degradation index, and the like.
(4) Model training: the preprocessed training set is taken as input data for model training and the degradation index constructed above is taken as a label, which are input into the improved Mamba degradation prediction model based on attention mechanism fusion as shown in FIG. 1 together, and in a training process, the parameters are optimized through back-propagation of a regression loss to obtain optimal network model parameters. A loss function adopts the root mean square error (RMSE) loss function, and this loss function can give a greater weight to a larger prediction error in a process of gradient back-propagation, which prompts the model to pay more attention to reducing these larger errors, thereby improving a prediction accuracy and a convergence speed of the model.
(5) Model evaluation and parameter adjustment: after completing the model training, an effect of the model is evaluated by using the verification set, a RMSE, a MAE and other indexes on the verification set are calculated, and a comparison effect between a predicted performance and a real label of the model on the verification set is observed. Superparameters of the model, such as a learning rate and a quantity of hidden layer units, are adjusted according to a prediction effect of the verification set, and a model with an optimal performance in the training process is saved.
(6) Model testing and application: degradation data in the test set or an actual task are input into the model with the optimal performance, and a degradation value of the part is output to achieve a degradation trend prediction task of the mechanical part.

In the embodiment of the present invention, the gamma distribution with the time-varying shape parameter and the initial degradation offset is used in the present invention to describe the degradation process of the mechanical part due to wear and other reasons, and meanwhile, the Bayesian inference is adopted for parameter estimation of data distribution in the degradation process, so as to achieve the dynamic adjustment of the degradation index and the uncertainty evaluation under the degradation state of the part. Subsequently, a calculation formula for the comprehensive degradation index is designed by combining the failure risk probability with the entropy value difference, and this index may be used to evaluate the health state of the mechanical part from multiple dimensions, thereby being a more comprehensive and accurate comprehensive degradation index. Finally, the degradation trend of the part is predicted by adopting the Mamba degradation prediction model based on attention mechanism fusion. With reference to the above contents, after the steps of the proposed system, the accurate degradation trend prediction of the mechanical part can be effectively achieved in practical application.

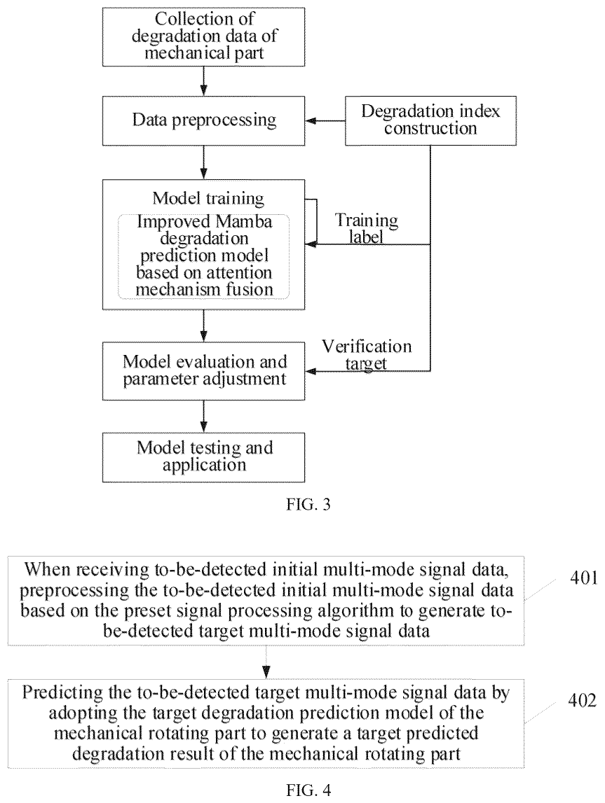

With reference to FIG. 4, FIG. 4 is a flow chart of steps of model prediction of a target degradation prediction model of a mechanical rotating part provided by Third Embodiment of the present invention.

For better description, FIG. 4 shows the flow chart of steps of model prediction of the target degradation prediction model of the mechanical rotating part provided by Third Embodiment of the present invention, and this process may comprise the following steps.

In step 401, when receiving to-be-detected initial multi-mode signal data, the to-be-detected initial multi-mode signal data are preprocessed based on the preset signal processing algorithm to generate to-be-detected target multi-mode signal data.

In step 402, the to-be-detected target multi-mode signal data are predicted by adopting the target degradation prediction model of the mechanical rotating part to generate a target predicted degradation result of the mechanical rotating part.

In the embodiment of the present invention, the Mamba degradation prediction model (the degradation prediction model of the mechanical rotating part) based on attention mechanism fusion is designed by combining a time evolution feature extraction advantage of the state space model with a selective integration advantage of an attention mechanism in the present invention, thereby accurately predicting the degradation process of the part.

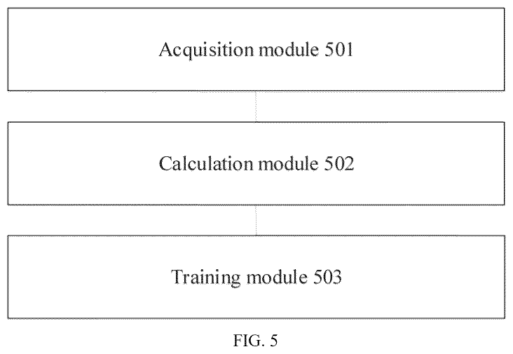

With reference to FIG. 5, FIG. 5 is a structural frame diagram of a multi-mode data modeling device for degradation prediction of a rotating part provided by Fourth Embodiment of the present invention.

The multi-mode data modeling device for degradation prediction of the rotating part provided by the present invention comprises:
an acquisition module 501 configured for acquiring to-be-trained initial multi-mode signal data, and preprocessing the to-be-trained initial multi-mode signal data based on a preset signal processing algorithm to generate to-be-trained target multi-mode signal data;
a calculation module 502 configured for calculating a degradation index according to the to-be-trained target multi-mode signal data by adopting a preset distribution function; and
a training module 503 configured for carrying out model training on an initial degradation prediction model of the mechanical rotating part by adopting the to-be-trained target multi-mode signal data and the degradation index to determine a target degradation prediction model of the mechanical rotating part.

Further, the preset signal processing algorithm comprises an improved ensemble empirical mode decomposition algorithm and a wavelet packet algorithm. The acquisition module 501 is specifically configured for:
adding a white noise to the to-be-trained initial multi-mode signal data to generate to-be-trained noise-containing signal data;
decomposing the to-be-trained noise-containing signal data by adopting the improved ensemble empirical mode decomposition algorithm, and outputting a plurality of multi-mode sub-signal data;
denoising the multi-mode sub-signal data by adopting the wavelet packet algorithm to generate a plurality of multi-mode denoised sub-signal data; and
reconstructing the plurality of multi-mode denoised sub-signal data based on a preset adaptive threshold, and outputting the to-be-trained target multi-mode signal data.

Further, the preset distribution function comprises an improved gamma distribution probability density function and a cumulative distribution function. The calculation module 502 is specifically configured for:
determining a gamma probability density distribution according to a continuous degradation amount in the to-be-trained target multi-mode signal data by adopting the improved gamma distribution probability density function;
substituting the continuous degradation amount in the to-be-trained target multi-mode signal data into the cumulative distribution function, and outputting a joint failure risk probability;
determining an instantaneous entropy value corresponding to the to-be-trained target multi-mode signal data based on the gamma probability density distribution;
carrying out a difference operation on the instantaneous entropy value and a historical entropy value corresponding to the to-be-trained target multi-mode signal data to determine an entropy value difference corresponding to the to-be-trained target multi-mode signal data; and
calculating the degradation index according to the entropy value difference and the joint failure risk probability.

Further, the training module 503 comprises:
a first sub-module configured for inputting the to-be-trained target multi-mode signal data into the initial degradation prediction model of the mechanical rotating part for prediction to generate a to-be-trained predicted degradation result of the mechanical rotating part;
a second sub-module configured for taking the degradation index as a real degradation result of the mechanical rotating part, and determining a model gradient according to the real degradation result of the mechanical rotating part and the to-be-trained predicted degradation result of the mechanical rotating part;
a third sub-module configured for updating model parameters of the initial degradation prediction model of the mechanical rotating part by adopting the model gradient to determine an intermediate degradation prediction model of the mechanical rotating part;
a fourth sub-module configured for determining a target loss value according to the to-be-trained target multi-mode signal data and the real degradation result of the mechanical rotating part by adopting the intermediate degradation prediction model of the mechanical rotating part and a preset root mean square error loss function;
a fifth sub-module configured for judging whether the target loss value is converged; and
a sixth sub-module configured for, when the target loss value is converged, taking the intermediate degradation prediction model of the mechanical rotating part as the trained target degradation prediction model of the mechanical rotating part.

Further, the initial degradation prediction model of the mechanical rotating part comprises an embedding layer, a plurality of Mamba blocks and a linear output layer. The first sub-module is specifically configured for:
mapping the to-be-trained target multi-mode signal data by adopting a time vector algorithm through the embedding layer to generate multi-mode mapped signal data;
carrying out efficient sequence processing on the multi-mode mapped signal data by adopting the plurality of Mamba blocks to generate a target degradation feature; and
taking the target degradation feature as an input of the linear output layer, and outputting the to-be-trained predicted degradation result of the mechanical rotating part.

Optionally, the Mamba block comprises a first linear layer, a second linear layer, a third linear layer, a SiLU activation function layer, a dimensional channel attention module and a state space module; and a data processing process of the Mamba block comprises:
linearly transforming input multi-mode signal data input into the Mamba block through the first linear layer and the second linear layer respectively to generate a first multi-mode transformed signal feature and a second multi-mode transformed signal feature;
nonlinearly mapping the first multi-mode transformed signal feature by adopting the SiLU activation function layer, and outputting a multi-mode nonlinear signal feature;
carrying out cross-dimensional channel information capture on the second multi-mode transformed signal feature through the dimensional channel attention module to generate a multi-mode attention signal feature;
multiplying the multi-mode attention signal feature and the second multi-mode transformed signal feature, and outputting a first multi-mode multiplied signal feature;
carrying out feature extraction on the first multi-mode multiplied signal feature by adopting the state space module to generate a signal degradation feature;
multiplying the signal degradation feature and the multi-mode nonlinear signal feature, and outputting a second multi-mode multiplied signal feature; and
linearly transforming the second multi-mode multiplied signal feature by adopting the third linear layer to generate an output signal feature.

In one optional device embodiment, the device further comprises:
a first module configured for, when receiving to-be-detected initial multi-mode signal data, preprocessing the to-be-detected initial multi-mode signal data based on the preset signal processing algorithm to generate to-be-detected target multi-mode signal data; and
a second module configured for predicting the to-be-detected target multi-mode signal data by adopting the target degradation prediction model of the mechanical rotating part to generate a target predicted degradation result of the mechanical rotating part.

It can be clearly understood by those skilled in the art that, for the sake of convenience and brevity in description, detailed working processes of the foregoing device, modules and sub-modules may refer to corresponding processes in the foregoing method embodiments, which will not be repeated herein.

The embodiment of the present invention further provides a computer device, which comprises a storage and a processor, wherein the storage stores a computer program, and when the computer program is executed by the processor, the processor executes the steps of the multi-mode data modeling method for degradation prediction of the rotating part according to any embodiment above.

The embodiment of the present invention further provides a computer-readable storage medium, which stores a computer program/instruction, wherein, when the computer program/instruction is executed by the processor, the steps of the multi-mode data modeling method for degradation prediction of the rotating part according to any embodiment above are implemented.

In the several embodiments provided in the present application, it should be understood that the disclosed device and method may be implemented in other ways. For example, the foregoing device embodiments are only illustrative. For example, the division of the units is only one logical function division. In practice, there may be other division methods. For example, multiple units or assemblies may be combined or integrated into another system, or some features may be ignored or not executed. In addition, the illustrated or discussed mutual coupling or direct coupling or communication connection may be indirect coupling or communication connection through some interfaces, devices or units, and may be in electrical, mechanical or other forms.

The units illustrated as separated parts may be or not be physically separated, and the parts displayed as units may be or not be physical units, which means that the parts may be located in one place or distributed on multiple network units. Some or all of the units may be selected according to actual needs to achieve the objects of the solutions of the embodiments.

As mentioned above, the above embodiments are only used to illustrate the technical solution of the invention, rather than limiting the present invention; although the present invention has been described in detail with reference to the foregoing embodiments, those of ordinary skills in the art should understand that: he can still modify the technical solutions set forth by the above embodiments, or make equivalent substitutions to part of the technical features of them. However, these modifications or substitutions shall not depart from the spirit and scope of the technical solutions of the embodiments of the present invention.

We claim:

1. A multi-mode data modeling method for degradation prediction of a rotating part, comprising the following steps of:
comprehensively monitoring a mechanical part of equipment by using multi-source sensors, acquiring initial multi-mode signal data of a whole life cycle of the mechanical part of the equipment, and preprocessing the to-be-trained initial multi-mode signal data based on a preset signal processing algorithm to generate to-be-trained target multi-mode signal data; wherein, the initial multi-mode signal data comprise a temperature and a vibration;
calculating a degradation index according to the to-be-trained target multi-mode signal data by adopting a preset distribution function; and
carrying out model training on an initial degradation prediction model of the mechanical rotating part by adopting the to-be-trained target multi-mode signal data and the degradation index to determine a target degradation prediction model of the mechanical rotating part;
wherein, the preset distribution function comprises an improved gamma distribution probability density function and a cumulative distribution function; and the step of calculating the degradation index according to the to-be-trained target multi-mode signal data by adopting the preset distribution function, comprises:
determining a gamma probability density distribution according to a continuous degradation amount in the to-be-trained target multi-mode signal data by adopting the improved gamma distribution probability density function;
substituting the continuous degradation amount in the to-be-trained target multi-mode signal data into the cumulative distribution function, and outputting a joint failure risk probability;
determining an instantaneous entropy value corresponding to the to-be-trained target multi-mode signal data based on the gamma probability density distribution;
carrying out a difference operation on the instantaneous entropy value and a historical entropy value corresponding to the to-be-trained target multi-mode signal data to determine an entropy value difference corresponding to the to-be-trained target multi-mode signal data; and
calculating the degradation index according to the entropy value difference and the joint failure risk probability;
wherein, a calculation process of the joint failure risk probability is specifically as follows:
$${R}_{C} = P ( V > {τ}_{v} , T > {τ}_{t} ) = 1 - C ( {F}_{V} ( {τ}_{v} ) , {F}_{T} ( {τ}_{t} ) ) ;$$
wherein, R_{C} is the joint failure risk probability; τᵥ is a threshold of a vibration degradation amount; τₜ is a threshold of a temperature degradation amount; V is the vibration degradation amount; T is the temperature degradation amount; F_{V}(·) and F_{T}(·) are respectively cumulative distribution functions of the vibration and temperature degradation amounts; and C is a Gaussian Couple function; and
a calculation process of the degradation index is specifically as follows:
$$D I = λ {R}_{C} ( t ) + μ ( Δ {H}_{V} ( t ) + Δ {H}_{T} ( t ) ) ;$$
wherein, DI is the degradation index; λ is a weight factor of the failure risk probability; R_{C}(t) is a joint failure risk probability at a moment t; μ is a weight factor of the entropy value difference; ΔH_{V}(t) is an entropy value difference corresponding to a vibration variable; and ΔH_{T}(t) is an entropy value difference corresponding to a temperature variable.

2. The multi-mode data modeling method for degradation prediction of the rotating part according to claim 1, wherein the preset signal processing algorithm comprises an improved ensemble empirical mode decomposition algorithm and a wavelet packet algorithm; and the step of preprocessing the to-be-trained initial multi-mode signal data based on the preset signal processing algorithm to generate the to-be-trained target multi-mode signal data, comprises:
adding a white noise to the to-be-trained initial multi-mode signal data to generate to-be-trained noise-containing signal data;
decomposing the to-be-trained noise-containing signal data by adopting the improved ensemble empirical mode decomposition algorithm, and outputting a plurality of multi-mode sub-signal data;
denoising the multi-mode sub-signal data by adopting the wavelet packet algorithm to generate a plurality of multi-mode denoised sub-signal data; and
reconstructing the plurality of multi-mode denoised sub-signal data based on a preset adaptive threshold, and outputting the to-be-trained target multi-mode signal data.

3. The multi-mode data modeling method for degradation prediction of the rotating part according to claim 1, wherein the step of carrying out the model training on the initial degradation prediction model of the mechanical rotating part by adopting the to-be-trained target multi-mode signal data and the degradation index to determine the target degradation prediction model of the mechanical rotating part, comprises:
inputting the to-be-trained target multi-mode signal data into the initial degradation prediction model of the mechanical rotating part for prediction to generate a to-be-trained predicted degradation result of the mechanical rotating part;
taking the degradation index as a real degradation result of the mechanical rotating part, and determining a model gradient according to the real degradation result of the mechanical rotating part and the to-be-trained predicted degradation result of the mechanical rotating part;
updating model parameters of the initial degradation prediction model of the mechanical rotating part by adopting the model gradient to determine an intermediate degradation prediction model of the mechanical rotating part;
determining a target loss value according to the to-be-trained target multi-mode signal data and the real degradation result of the mechanical rotating part by adopting the intermediate degradation prediction model of the mechanical rotating part and a preset root mean square error loss function;
judging whether the target loss value is converged; and
when the target loss value is converged, taking the intermediate degradation prediction model of the mechanical rotating part as the trained target degradation prediction model of the mechanical rotating part.

4. The multi-mode data modeling method for degradation prediction of the rotating part according to claim 3, wherein the initial degradation prediction model of the mechanical rotating part comprises an embedding layer, a plurality of Mamba blocks and a linear output layer; and the step of inputting the to-be-trained target multi-mode signal data into the initial degradation prediction model of the mechanical rotating part for prediction to generate the to-be-trained predicted degradation result of the mechanical rotating part, comprises:
mapping the to-be-trained target multi-mode signal data by adopting a time vector algorithm through the embedding layer to generate multi-mode mapped signal data;
carrying out efficient sequence processing on the multi-mode mapped signal data by adopting the plurality of Mamba blocks to generate a target degradation feature; and
taking the target degradation feature as an input of the linear output layer, and outputting the to-be-trained predicted degradation result of the mechanical rotating part.

5. The multi-mode data modeling method for degradation prediction of the rotating part according to claim 4, wherein the Mamba block comprises a first linear layer, a second linear layer, a third linear layer, a SiLU activation function layer, a dimensional channel attention module and a state space module; and a data processing process of the Mamba block comprises:
linearly transforming input multi-mode signal data input into the Mamba block through the first linear layer and the second linear layer respectively to generate a first multi-mode transformed signal feature and a second multi-mode transformed signal feature;
nonlinearly mapping the first multi-mode transformed signal feature by adopting the SiLU activation function layer, and outputting a multi-mode nonlinear signal feature;
carrying out cross-dimensional channel information capture on the second multi-mode transformed signal feature through the dimensional channel attention module to generate a multi-mode attention signal feature;
multiplying the multi-mode attention signal feature and the second multi-mode transformed signal feature, and outputting a first multi-mode multiplied signal feature;
carrying out feature extraction on the first multi-mode multiplied signal feature by adopting the state space module to generate a signal degradation feature;
multiplying the signal degradation feature and the multi-mode nonlinear signal feature, and outputting a second multi-mode multiplied signal feature; and
linearly transforming the second multi-mode multiplied signal feature by adopting the third linear layer to generate an output signal feature.

6. The multi-mode data modeling method for degradation prediction of the rotating part according to claim 1, further comprising the following steps of:
when receiving to-be-detected initial multi-mode signal data, preprocessing the to-be-detected initial multi-mode signal data based on the preset signal processing algorithm to generate to-be-detected target multi-mode signal data; and
predicting the to-be-detected target multi-mode signal data by adopting the target degradation prediction model of the mechanical rotating part to generate a target predicted degradation result of the mechanical rotating part.

7. A multi-mode data modeling device for degradation prediction of a rotating part applied in the multi-mode data modeling method for degradation prediction of the rotating part according to claim 1, comprising:
an acquisition module configured for comprehensively monitoring a mechanical part of equipment by using multi-source sensors, acquiring initial multi-mode signal data of a whole life cycle of the mechanical part of the equipment, and preprocessing the to-be-trained initial multi-mode signal data based on a preset signal processing algorithm to generate to-be-trained target multi-mode signal data; wherein, the initial multi-mode signal data comprise a temperature and a vibration;
a calculation module configured for calculating a degradation index according to the to-be-trained target multi-mode signal data by adopting a preset distribution function; and
a training module configured for carrying out model training on an initial degradation prediction model of the mechanical rotating part by adopting the to-be-trained target multi-mode signal data and the degradation index to determine a target degradation prediction model of the mechanical rotating part.

8. A computer device, comprising a storage and a processor, wherein the storage stores a computer program, and when the computer program is executed by the processor, the processor executes the steps of the multi-mode data modeling method for degradation prediction of the rotating part according to claim 1.
